(19) United States
(12) Patent Application Publication
(10) Pub. No.: US 2010/0229211 A1
(43) Pub. Date: Sep. 9, 2010

(54) FAST CHANNEL CHANGE SYSTEM USING MULTIPLE MULTICASTS IN IPTV NETWORK AND METHOD THEREOF

(75) Inventors: Byung-Tak Lee, Suwon-city (KR); Sang-Hyeun Lee, Gwangjoo-city (KR); Seung-Hun Oh, Gwangjoo-city (KR); Jae-Chan Shim, Daejeon-city (KR); Ho-Young Song, Daejeon-city (KR); Bong-Tae Kim, Daejeon-city (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon-city (KR)

(21) Appl. No.: 12/677,892

(22) PCT Filed: Apr. 24, 2008
(86) PCT No.: PCT/KR2008/002326

§ 371 Date: Mar. 12, 2010

(30) Foreign Application Priority Data
Sep. 14, 2007 (KR) 10-2007-0093814

(51) Int. Cl. H04N 7/173

(52) U.S. Cl. 725/109; 370/390

(57) ABSTRACT

Provided are a fast channel change apparatus based on multiple multicasts communication in an IPTV network, and a method thereof. In the fast channel change system, after separately generating at least one multicast stream obtained by applying different time delays respectively to original multicast stream to be broadcast, a channel server dynamically analyzes information regarding the at least one multicast stream. After querying the channel server for information regarding an optimal multicast stream and receiving the response to the query, a user terminal joins a multicast group on the optimal multicast stream through a router. After a predetermined time is elapsed, the user terminal joins a multicast group of the original multicast stream. Thus, it is possible to easily and inexpensively embody a fast channel change function network based on multiple multicasts communication in an IPTV network.

### TECHNICAL FIELD

The present invention relates to a fast channel change system based on multiple multicasts communication in an IPTV network and a method thereof, and more particularly, to a fast channel change system in which a channel server generates at least one multicast stream, a user terminal sends a query about an optimal multicast stream to the channel server when a user changes an IPTV channel, the channel server determines and sends an information about the optimal multicast stream to the user terminal, the user terminal changes the channel by using the informed optimal multicast stream, and a method thereof.

This application claims the benefit of Korean Patent Application No. 10-2007-0093814, filed on Sep. 14, 2007, in the Korean Intellectual Property Office, the disclosure of which is incorporated herein in its entirety by reference.

### BACKGROUND ART

An Internet protocol TV (IPTV) service is a system where digital television service is delivered based on an IP network. A channel changing speed is a very important factor in satisfying a user in a real time broadcasting service, which is a basis of the IPTV service. The channel changing speed of a real time broadcasting service provided through a conventional analog network is equal to or less than one second. However, the channel changing speed of the real time broadcasting service provided through the IPTV network generally takes several seconds. Accordingly, the channel changing speed needs to be improved so as to provide the IPTV service.

Factors influencing the channel changing speed in the IPTV network based on multicast communication include a time of transmitting an interne group management protocol (IGMP) from a user terminal to a router, a time of transmitting a multicast stream from the router to the user terminal, a stream buffering time, a program ID (PID) detection time, a time due to a structure of a group of pictures (GOP) to search for an independent-frame (I-frame), a stream decoding time, a screen print time, and the like. The time of transmitting the IGMP from the user terminal to the router, the time of transmitting the multicast stream from the router to the user terminal, the stream decoding time, the screen print time, and the like are basic elements. The stream buffering time, the PID detection time, the GOP structure for searching for the I-frame, and the like are elements that can be technically improved.

In a conventional technique, a channel is changed fast by transmitting a video stream including an I-frame as the forefront through unicast communication by using a video stream included in a buffer for each client which requests for a channel to be changed. Since the I-frame of the video stream included in each client which requests for a channel to be changed can be provided the fastest by using the aforestated method, it is possible to change a channel faster in principle. However, since in the method, the video stream is transmitted through unicast communication, if the number of requesting clients is large, there is a large load in the fast channel change server and the network.

In another conventional technique, a structure in which a low bit rate/low quality stream and a high bit rate/high quality stream are prepared, the low bit rate/low quality stream is reproduced at first by reducing a stream buffering time, and the stream that is gradually switched to the high bit rate/high quality stream is used. However, since the method also provides a service based on unicast communication, if the number of clients is large, there is a large load in a server and a network.

In another conventional technique, a GOP is stored in an access network node buffer. If a user requests for a channel to be changed, the GOP is transmitted through unicast communication and changed to multicast communication through an alignment process with the multicast communication. However, since the aforementioned method also transmits a video stream through unicast communication, if the number of requesting clients is large, there is a large load in the fast channel change server and the network.

In another conventional technique, a stream PID of a channel to be transmitted is changed to a fixed value. When a terminal decodes a stream, a fixed PID is used. However, in the method, there is a load of the server which has to modify the stream PID of the channel, and thus, it is impossible to reduce a time delay due to the GOP structure.

### DISCLOSURE OF INVENTION

### Technical Problem

There are technical limits of a fast channel changing technique due to a separate transmission of a video stream through unicast communication.

### Technical Solution

The present invention provides a fast channel change system in which a channel server generates at least one multicast stream, a user terminal sends a query about an optimal multicast stream to the channel server when a user changes an IPTV channel, the channel server determines and sends an information about the optimal multicast stream to the user terminal, the user terminal changes the channel by using the informed optimal multicast stream, and a method thereof so as to overcome technical limits of a fast channel changing technique due to a separate transmission of a video stream through unicast communication.

Other objects and advantages of the present invention will be understood in the following description, and more clearly understood in embodiments of the present invention. In addition, it is easily understood that the objects and advantages of the present invention can be embodied by means and their combination defined by the appended claims.

### ADVANTAGEOUS EFFECTS

In the fast channel change system according to an embodiment of the present invention, the channel server enables the user terminal to perform a fast channel change by using an optimal multicast stream by providing information regarding the optimal multicast stream to the user terminal, after separately generating at least one multicast stream obtained by applying different time delays respectively to the original multicast stream to be broadcast.

Accordingly, service providers can easily and inexpensively embody a fast channel change function in an IPTV network based on multiple multicasts communication.

### DESCRIPTION OF DRAWINGS

The above and other features and advantages of the present invention will become more apparent by describing in detail exemplary embodiments thereof with reference to the attached drawings in which:

FIG. 1 is a schematic block diagram illustrating a fast channel change system according to an embodiment of the present invention;

FIG. 2 illustrates the main structures of a channel server and a user terminal in the fast channel change system of FIG. 1, and a main signal flow among a channel server, a user terminal, and a router, according to an embodiment of the present invention;

FIG. 3 illustrates detailed interactions of a channel server, a router, and a user terminal, according to an embodiment of the present invention;

FIG. 4 illustrates a flow of a fast channel change method using multiple multicasts communication in an IPTV network, according to an embodiment of the present invention;

FIG. 5 illustrates a flow of a fast channel change method using multiple multicasts communication in an IPTV network, according to an embodiment of the present invention;

FIG. 6 is a flowchart of a fast channel change method using multiple multicasts communication in an IPTV network, according to another embodiment of the present invention, from a view of the channel server; and

FIG. 7 is a flowchart of a fast channel change method using multiple multicasts communication in an IPTV network, according to another embodiment of the present invention, from a view of the user terminal.

### BEST MODE

According to an aspect of the present invention, there is provided a channel server for an internet protocol TV (IPTV) fast channel change using multiple multicasts, the channel server comprising: a multiple multicasts module generating one or more delayed multicast streams by respectively applying different time delays to original multicast stream to be broadcast; and a channel analysis module receiving a query from a user terminal for information regarding a channel changed by a user; determining an optimal multicast stream by analyzing the delayed multicast streams of an original multicast stream corresponding to the changed channel; and providing information regarding the optimal multicast stream to the user terminal as a response to the query.

According to another aspect of the present invention, there is provided a user terminal including: a channel query module querying the channel server which generates one or more delayed multicast streams by respectively applying different time delays to original multicast stream, for a channel changed by the user and receiving information regarding the optimal multicast stream selected from among the delayed multicast streams of the original multicast stream corresponding to the changed channel, in response to the query; an IGMP module requesting for the optimal multicast stream to the router using the optimal multicast stream information; a stream parsing module receiving the optimal multicast stream from the router and parsing the optimal multicast stream; and a stream decoder decoding the parsed multicast stream to output to a display.

According to another aspect of the present invention, there is provided an IPTV fast channel change system comprising: a channel server generating one or more delayed multicast streams by respectively applying different time delays to original multicast stream, and determining the optimal multicast stream by analyzing the delayed multicast streams of the original multicast stream corresponding to the changed channel; and a user terminal querying the channel server for information regarding a channel changed by the user, and receiving the optimal multicast stream from the router using the information of the optimal multicast stream which is received as a response to the query from the channel server and outputting the optimal multicast stream.

According to another aspect of the present invention, there is provided an IPTV fast channel change method using multiple multicasts by a channel server, the IPTV fast channel change method comprising: generating at least one delayed multicast stream by applying different time delays respectively to original multicast stream; receiving a query from a user terminal for information regarding a channel changed by a user; determining an optimal multicast stream by analyzing the delayed multicast streams of an original multicast stream corresponding to the changed channel; and providing information regarding the optimal multicast stream to the user terminal as a response to the query.

According to another aspect of the present invention, there is provided an IPTV fast channel change method using multiple multicasts by a user terminal, the IPTV fast channel change method comprising: querying a channel server, which generates at least one delayed multicast stream by applying different time delays respectively to original multicast stream, for information regarding a channel changed by a user; receiving, from the channel server, information regarding an optimal multicast stream determined among the delayed multicast streams of an original multicast stream corresponding to the changed channel as a response; requesting the optimal multicast stream by using the information regarding the optimal multicast stream to a router; receiving the optimal multicast stream from the router and parsing the optimal multicast stream; and decoding the parsed multicast stream and outputting to a display.

According to another aspect of the present invention, there is provided an IPTV fast channel change method using multiple multicasts, the IPTV fast channel change method comprising: generating at least one delayed multicast stream by applying different time delays respectively to original multicast stream, by a channel server; querying for information regarding a channel changed by a user, by a user terminal; determining an optimal multicast stream by analyzing the delayed multicast streams of an original multicast stream corresponding to the changed channel, by the channel server; providing information regarding the optimal multicast stream to the user terminal as a response to the query, by the channel server; and receiving the optimal multicast stream from the router using the optimal multicast stream information and outputting the optimal multicast stream, by the user terminal.

According to another aspect of the present invention, there is provided a computer readable medium having embodied thereon a computer program for executing the above-described IPTV fast channel change method using multiple multicasts.

### MODE FOR INVENTION

Hereinafter, embodiments of the present invention will be described in detail with reference to the attached drawings. Like reference numerals in the drawings denote like elements. When it is determined that the detailed descriptions of the known techniques or structures related to the present invention depart from the scope of the invention, the detailed descriptions will be omitted.

In addition, it will understood that when an element is referred to as ‘including’ or ‘comprising’ another element, it can include still another element, if there is no specific description.

In addition, a module indicates a unit for performing a predetermined function or operation. The module may be embodied with hardware, software, or a combination of hardware and software.

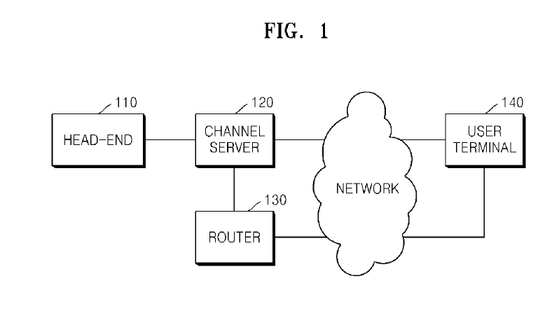

FIG. 1 is a schematic block diagram illustrating a fast channel change system according to an embodiment of the present invention.

Referring to FIG. 1, the fast channel change system includes a head-end 110, a channel server 120, a router 130, and a user terminal 140 in an internet protocol TV (IPTV) network.

In the fast channel change system, after the channel server 120 separately generates one or more delayed multiple multicasts streams by applying different time delays respectively to original multicast streams to be broadcast, the channel server 120 dynamically analyzes information regarding the delayed multiple multicasts streams. After the user terminal 140 queries the channel server 120 for information regarding an optimal multicast stream and receives the response to the query, the user terminal 140 joins a multicast group on the optimal multicast stream (hereinafter referred to as ‘optimal multicast group’) through the router 130. After a predetermined time is elapsed, the user terminal 140 joins a multicast group on the original multicast stream (hereinafter referred to as ‘original multicast group’). The optimal multicast stream indicates a stream that can provide an independent frame (I-frame) to the user terminal 140 the fastest among one or more multicast streams applied different time delays.

The head-end 110 provides a broadcast multicast stream to the channel server 120.

The channel server 120 receives the original multicast stream to be broadcast by directly receiving the original multicast stream from the head-end 110 or from the head-end 110 via a switch (not shown). The channel server 120 generates the one or more delayed multiple multicasts streams by applying different time delays respectively to the original multicast stream and transmits the one or more delayed multiple multicasts streams to the router 130. The channel server 120 determines the optimal multicast stream by analyzing the one or more delayed multiple multicasts streams of the original multicast stream corresponding to a changed channel, and provides information regarding the optimal multicast stream as the response to the query by the user terminal 140.

The channel server 120 may be connected directly to the router 130 or connected to the router 130 via the switch (not shown) that serves to extend a connection, so as to perform a function of an Internet group management protocol (IGMP) for allowing the user terminal 140 to receive a multicast stream fast.

The router 130 receives a multicast stream from the channel server 120 and provides the corresponding multicast stream to the user terminal 140.

The user terminal 140 is connected to the channel server 120 and the router 130 through an IP network, and corresponds to a personal computer (PC) or a set-top box. The user terminal 140 queries the channel server 120 for information regarding a channel changed by a user, receives information regarding the channel changed by the user, and receives a multicast stream corresponding to the information, from the router 130, by using the information.

Hereinafter, detailed structures and operations of devices will be described in detail.

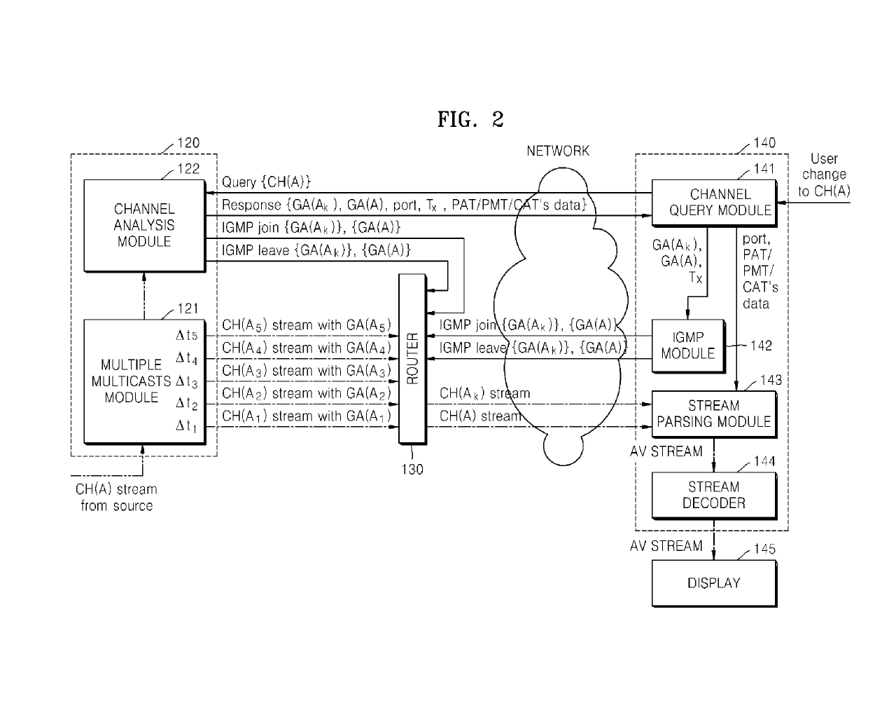

FIG. 2 illustrates the main structures of the channel server 120 and the user terminal 140 in the fast channel change system of FIG. 1, and main signal flows among the channel server 120, the user terminal 140, and the router 130 according to an embodiment of the present invention.

Referring to FIG. 2, the channel server 120 includes a multiple multicasts module 121 and a channel analysis module 122.

The multiple multicasts module 121 generates one or more delayed multiple multicasts streams by respectively applying different time delays to original multicast stream to be broadcast. Different multicast group addresses and/or different port values are allocated to the one or more delayed multiple multicasts streams. The delayed multiple multicasts streams, generated by the channel server 120, are temporary streams for a fast channel change. In the present invention, the user terminal 140 changes a channel to the optimal stream selected from among the temporary streams fast. After a predetermined time is elapsed, the channel is changed to the original multicast stream. Accordingly, a load of the IP network is reduced by removing a temporary stream that is used as the optimal multicast stream in the IP network. In FIG. 2, the multiple multicasts module 121 receives an original multicast stream CH(A) and generates five multicast streams CH(A₁) to CH(A₅) to which different time delays Δt₁ to Δt₅ are respectively applied. In case a time delay Δt₁=0 is applied, a multicast group address and a port value allocated to the multicast stream CH(A₁) are the same as those of the original multicast stream CH(A). In another embodiment, the original multicast stream is directly input into the router 130. Thus, the multiple multicasts module 121 generates one or more delayed multiple multicasts streams by applying different time delays, greater than zero second, respectively to the original multicast stream and enables the one or more delayed multiple multicasts streams to be input into the router 130.

The channel analysis module 122 dynamically analyzes information regarding the delayed multiple multicasts streams in real time. In FIG. 2, whenever receiving a query for the channel from the user terminal 140, the channel analysis module 122 determines the optimal multicast stream by analyzing the delayed multiple multicasts streams and transmits information regarding the optimal multicast stream to the user terminal 140 as a response to the query. The user terminal 140 changes a channel fast by receiving the optimal multicast stream. After a predetermined time is elapsed, the channel is changed to the original multicast stream. And the optimal multicast stream (temporary stream) in the IP network is removed, thus a load of the IP network is reduced.

The information regarding the optimal multicast stream includes a multicast group address GA(Aₖ) and a port value of the optimal multicast stream and program association information such as information regarding a program association table (PAT)/program map table (PMT)/conditional access table (CAT). In a case where the optimal multicast stream is not the original multicast stream, a multicast group address GA(A) and a port value of the original multicast stream and a transition time Tₓ of the user terminal 140 are additionally provided to the user terminal 140. The original multicast stream is the same as the delayed multiple multicasts stream of which the time delay is zero.

In addition, the channel analysis module 122 performs a temporary IGMP function, so that the user terminal 140 changes a channel fast by receiving the multicast stream fast. That is, the user terminal 140 joins and leaves the optimal multicast group, and joins and leaves the original multicast group through the router 130. In the present invention, a difference between a time of joining the optimal multicast group and a time of joining the original multicast group of the channel server 120 is defined as a transition time T_{Y} of the channel server 120.

The user terminal 140 includes a channel query module 141, an IGMP module 142, a stream parsing module 143, a stream decoder 144, and a display 145.

The channel query module 141 queries the channel server 120 for a channel changed by the user and receives information regarding the optimal multicast stream selected from among the delayed multiple multicasts streams of the original multicast stream corresponding to the changed channel, in response to the query. The query for the channel information includes a channel ID corresponding to the changed channel, and the information regarding the optimal multicast stream includes a multicast group address and a port value of the optimal multicast stream and program designation information that includes information regarding the PAT, the PMT, and the CAT.

The IGMP module 142 requests for the optimal multicast stream to the router 130. The IGMP module 142 may be connected to the router 130 or the switch connected to the router 130 by using a physical or logical port, from among interfaces of the router 130, in a direction of the user terminal 140. The IGMP module 142 requests for the optimal multicast stream to the router 130 by joining the optimal multicast group through the router 130 based on the multicast group address of the optimal multicast stream, which is included in the information regarding the optimal multicast stream. In addition, the IGMP module 142 receives the information regarding the original multicast stream from the channel server 120 and joins the optimal multicast group. After the transition time Tₓ of the user terminal 140 is elapsed, the IGMP module 142 requests for the original multicast stream by joining the original multicast group through the router 130 based on the multicast group address of the original multicast stream.

The transition time Tₓ of the user terminal 140 is determined by Tₓ=T_{GoP}−T₀+n×T_{GoP}+α, in real time. Here, n is zero or a natural number, T_{GoP} is a time occupied by a group of pictures (GOP), T₀ is a time calculated by using a distance between a current position of an I-frame on a stream buffer and an entrance to the stream buffer in the multiple multicasts module 121, and α is a compensation parameter determined by considering an arrival time of an information query by the user terminal 140, a delay time of processing the multicast stream of the channel server 120, a network delay time between the channel server 120 and the router 130, and a network delay time between the router 130 and the user terminal 140.

After receiving the original multicast stream and moving to the original multicast stream, the user terminal 140 leaves the optimal multicast group so as to reduce a load of the IP network so as to not waste network bandwidth. In addition, when the user changes the channel to another channel, the user terminal 140 also leaves the original multicast group.

The stream parsing module 143 receives a port value of the optimal multicast stream and PAT/PMT/CAT information, practically receives the multicast stream from the router 130, and parses the multicast stream.

The stream decoder 144 decodes an audio-video (AV) stream parsed by the stream parsing module 143 and outputs the decoded AV stream to the display 145.

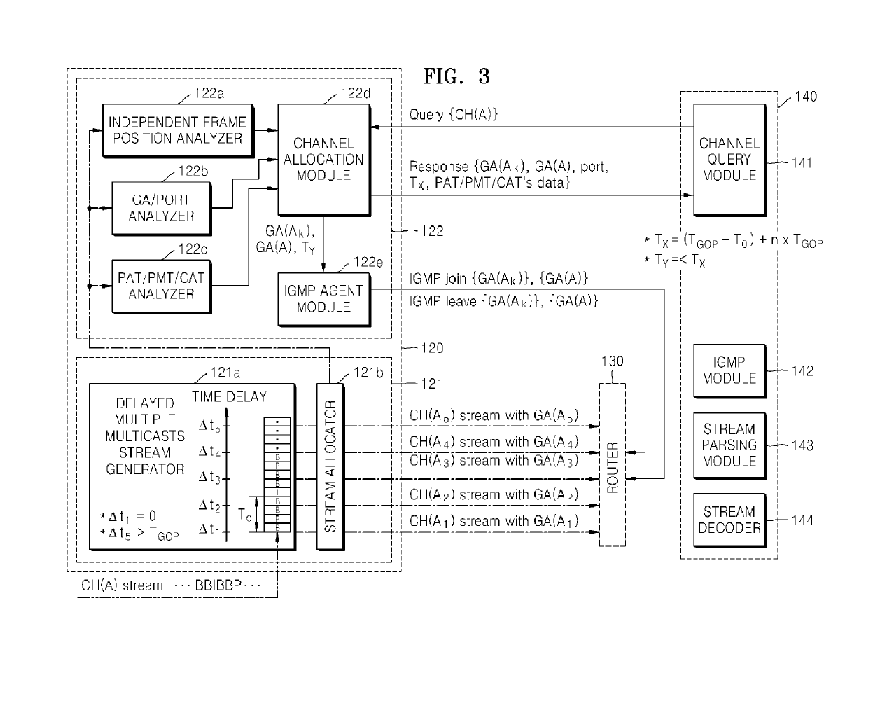

FIG. 3 illustrates the detailed structure of the channel server 120 and the detailed interactions among the channeled server 120, the router 130, and the user terminal 140, according to an embodiment of the present invention.

Referring to FIG. 3, the multiple multicasts module 121 includes a delayed multiple multicasts stream generator 121a and a stream allocator 121b.

The delayed multiple multicasts stream generator 121a generates one or more delayed multicast streams by applying different time delays respectively to original multicast stream. The delayed multiple multicasts stream generator 121a may be embodied by using one or more linear or ring type stream buffers.

The different time delays are previously set values with a predetermined interval. The minimum delay may be zero, and the maximum delay may be greater than a time T_{GoP} occupied by the GOP of the original (or delayed) multicast stream (for example, Δt₅>T_{GoP}). The delayed multicast stream with the minimum delay of zero corresponds to the original multicast stream.

The stream allocator 121b allocates different multicast group addresses GA and port values to the delayed multicast streams, respectively.

As described above, after receiving a query for information regarding the optimal multicast stream from the user, the channel analysis module 122 analyzes and determines the optimal multicast stream. The channel analysis module 122 includes an independent frame (I-frame) position analyzer 122a, a GA/port number analyzer 122b, a PAT/PMT/CAT data analyzer 122c, a channel allocation module 122d, and an IGMP agent module 122e.

The I-frame position analyzer 122a analyzes a relative time position of an I-frame that is independently decodable with respect to the original multicast stream that is input into the multiple multicasts module 121 in real time. That is, a stream buffer in the delayed multiple multicasts stream generator 121a analyzes a relative time position T₀ of the independently decodable I-frame like an I-frame of MPEG in real time. The relative time position T₀ is a time value calculated by using a distance between a current position of an I-frame in the stream buffer and an entrance to the stream buffer.

The GA/port number analyzer 122b analyzes multicast group addresses and port values of the delayed multicast streams.

The PAT/PMT/CAT/data analyzer 122c analyzes program designation information such as information regarding the PAT, the PMT, and the CAT of a stream. The analyzed program designation information is the same with respect to the original multicast stream and the delayed multicast stream.

The channel allocation module 122d dynamically determines a delayed multicast stream which can provide an I-frame the fastest among the at least one delayed multicast streams based on the analysis result obtained by the independent frame position analyzer 122a, the GA/port number analyzer 122b, and the PAT/PMT/CAT analyzer 122c, as the optimal multicast stream. At this time, it is preferable to determine the optimal multicast stream by considering an arrival time of an information query by the user terminal 140, a delay time of processing the multicast stream of the channel server, a network delay time between the channel server 120 and the router, and a network delay time between the router 130 and the user terminal 140.

In addition, a difference between a time when the user terminal 140 joins the optimal multicast group and a time when the user terminal 140 joins the original multicast group through the router 130, that is, a transition time Tₓ of the user terminal, which is defined as a time period from the time when the user terminal joins the optimal multicast group to the time when the user terminal joins the original multicast group, is determined in real time. And a difference between a time when the channel server 120 joins the optimal multicast group and a time when the channel server 120 joins the original multicast group through the router 130, that is, a transition time T_{Y} of the channel server 120, which is defined as a time period from the time when the channel server 120 joins the original multicast group to a time when the channel server 120 joins the original multicast group, is determined in real time. The transition time T_{Y} of the channel server 120 is equal to or less than the transition time Tₓ of the user terminal 140.

Tₓ=T_{GoP}−T₀+n·T_{GoP}+α (1)

Here, n is zero or a natural number, α is a compensation parameter determined by considering an arrival time of an information query by the user terminal 140, a delay time of processing the multicast stream of the channel server 120, a network delay time between the channel server 120 and the router 130, and a network delay time between the router 130 and the user terminal 140, and T₀ is a relative time position of an I-frame.

In addition, the channel allocation module 122d provides information regarding the optimal multicast stream including a multicast group address and a port value of the optimal multicast stream and the program designation information, in response the query for the channel information by the user terminal 140. In addition, the multicast group address and the port value of the original multicast stream and the transition time Tₓ of the user terminal 140 are additionally provided to the user terminal 140. The original multicast stream is the same as the delayed multicast stream of which the delayed value is zero.

The IGMP agent module 122e performs a temporary IGMP function, so that the user terminal 140 receives a multicast stream fast. The IGMP agent module 122e joins the optimal multicast group through the router 130 by using the multicast group address of the optimal multicast stream, which is received from the channel allocation module 122d, so that the user terminal 140 receives the optimal multicast stream fast. The user terminal 140 joins the optimal multicast group at the same time when the information regarding the optimal multicast stream is provided to the user terminal 140. After a time for which the user terminal 140 joins the optimal multicast group and receives the multicast stream is elapsed, the user terminal 140 leaves the optimal multicast group.

In addition, the user terminal 140 joins the original multicast group through the router 130 by using the IGMP and the multicast group address of the original multicast stream, so that the user terminal 140 receives the original multicast stream fast. After a time for which the user terminal 140 joins the optimal multicast group and receives the multicast stream is elapsed, the user terminal 140 leaves the optimal multicast group.

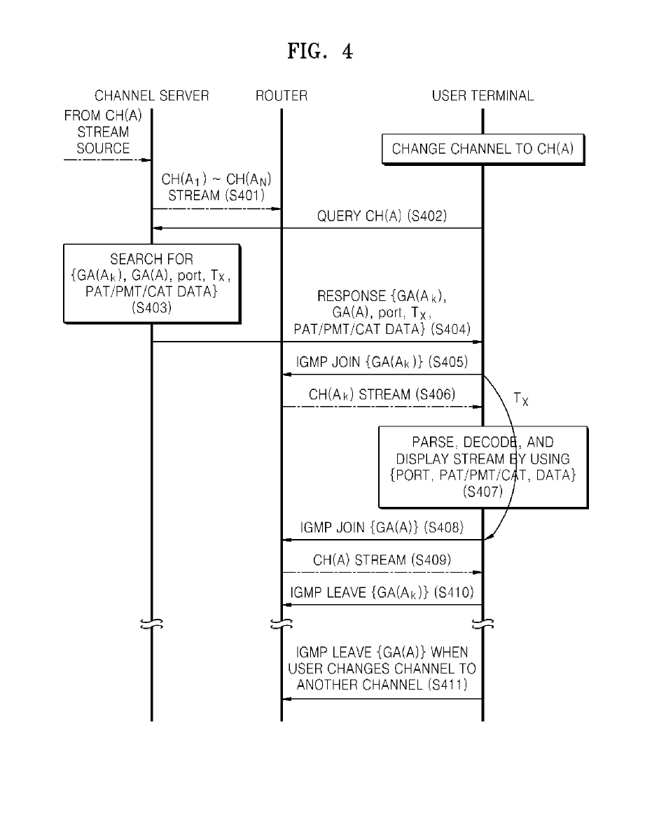

FIG. 4 illustrates a flow of a fast channel change method using multiple multicasts communication in an IPTV network, according to an embodiment of the present invention. Hereinafter, a detailed description on the parts that are the same as the aforementioned description will be omitted.

Referring to FIG. 4, when the original multicast stream CH(A) is introduced into the channel server, the channel server 120 separately generates at least one multicast stream CH(A₁) to CH(A_{N}) by applying different time delays respectively to original multicast stream and outputs the at least one multicast stream CH(A₁) to CH(A_{N}) to the router (operation S401).

If the user changes a channel to the original multicast stream CH(A), a user terminal queries the channel server for information regarding a changed channel by using a previously determined channel ID such as a multicast group address of the channel (operation S402).

The channel server determines a delayed multicast stream capable of providing an I-frame the fastest based on a relative time position of the I-frame, a group address, a port value, program designation information, and the like, as the optimal multicast stream by analyzing at least one delayed multicast stream corresponding to the changed channel (operation S403).

The channel server additionally provides information regarding the optimal multicast stream CH(Aₖ) (the multicast group address of the optimal multicast stream, the port value of the optimal multicast stream, the PAT/PMT/CAT information, and the like), the multicast group address and the port value of the original multicast (or the delayed multicast stream of which the delayed value is zero), and the transition time Tₓ of the user terminal to the user terminal (operation S404).

The user terminal receives the optimal multicast stream from the router by using the information regarding the optimal multicast stream and outputs the optimal multicast stream. More specifically, the user terminal joins the multicast group through the router by using the multicast group address of the optimal multicast stream and the IGMP (operation S405). The user terminal receives the optimal multicast stream (operation S406). The user terminal parses, decodes, and displays the received optimal multicast stream by using the port value of the optimal multicast stream and the PAT/PMT/CAT information (operation S407).

Immediately after the transition time Tₓ of the user terminal is elapsed from when the user terminal receives the information regarding the optimal multicast stream (operation S404), the user terminal joins the original multicast group through the router by using the multicast group address of the original multicast stream and the IGMP (operation 5408) and receives the original multicast stream (operation S409).

The user terminal leaves the optimal multicast group, immediately when receiving the original multicast stream, so as to reduce a load of the IP network (operation S410).

Then, when the user changes the channel to another channel, the user terminal leaves the original multicast group of the original multicast stream (operation S411).

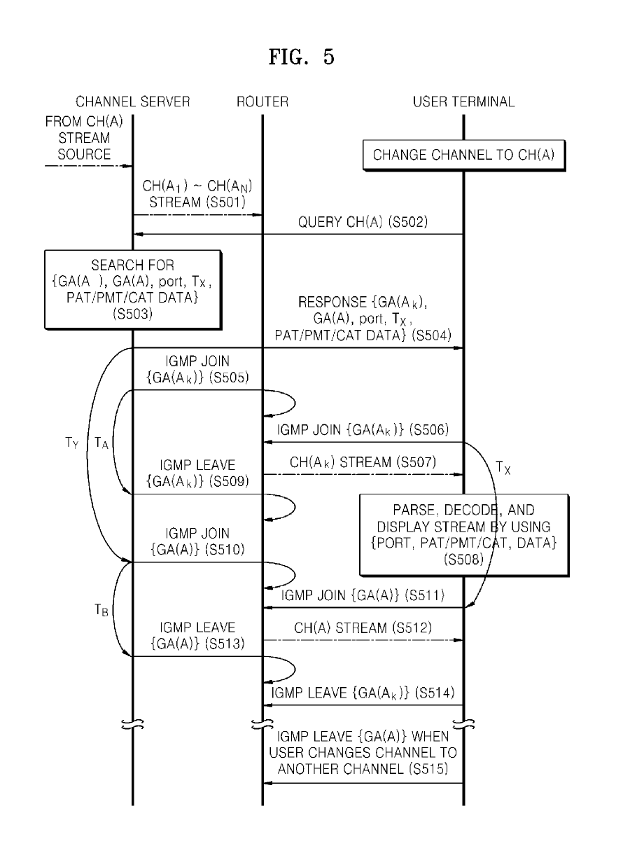

FIG. 5 illustrates a flowchart of a fast channel change method using multiple multicasts communication in an IPTV network, according to another embodiment of the present invention. Hereinafter, a detailed description on the parts that are the same as the aforementioned description will be omitted.

Referring to FIG. 5, the present embodiment is similar to that of FIG. 4, except that the channel server performs the temporary IGMP function so that the user terminal receives the multicast stream fast.

Referring to FIG. 5, when the original multicast stream CH(A) is introduced into the channel server, the channel server separately generates at least one multicast stream CH(A₁) to CH(A_{N}) by applying different time delays respectively to original multicast stream, and outputs the at least one multicast stream CH(A₁) to CH(A_{N}) to the router (operation S501).

If the user changes a channel to the original multicast stream CH(A), the user terminal queries the channel server for information regarding a changed channel by using a previously determined channel ID such as a multicast group address of the channel (operation S502).

The channel server determines a delayed multicast stream capable of providing the I-frame the fastest based on a relative time position of an I-frame, a group address, a port value, program designation information, and the like, as the optimal multicast stream by analyzing at least one delayed multicast stream corresponding to the changed channel (operation S503).

The channel server additionally provides information regarding the optimal multicast stream CH(Aₖ) (the multicast group address of the optimal multicast stream, the port value of the optimal multicast stream, the PAT/PMT/CAT information, and the like), the multicast group address of the original multicast stream (or the delayed multicast stream of which the delayed value is zero), the port value of the original multicast stream, and the transition time Tₓ of the user terminal to the user terminal (operation S504).

The channel server joins the optimal multicast group through the router by using the multicast group address of the optimal multicast stream and the IGMP at the same time with operation S504 (operation S505).

The user terminal joins the optimal multicast group through the router by using the optimal multicast group and the IGMP (operation S506) and receives the optimal multicast stream (operation S507).

The user terminal parses, decodes, and displays the optimal multicast stream received by using the port value of the optimal multicast stream and the PAT/PMT/CAT information (operation S508).

After a sufficient time T_{A} is elapsed in consideration of operations S506 and S507, the channel server leaves the optimal multicast group through the router by using the multicast group address of the optimal multicast stream and the IGMP so as to remove unnecessary multicast traffic from the channel server (operation S509).

Next, the channel server joins the original multicast group through the router by using the multicast group address of the original multicast stream and the IGMP immediately when the transition time T_{Y} of the channel server is elapsed, in operation S504, so that the user terminal receives the original multicast stream fast (operation S510).

Immediately after the transition time Tₓ of the user terminal is elapsed from when the user terminal receives the information regarding the optimal multicast stream (operation S504), the user terminal joins the original multicast group through the router by using the multicast group address of the original multicast stream and the IGMP (operation S511), and receives the original multicast stream (operation S512).

After a sufficient time T_{B} is elapsed in consideration of operations S511 and 512, the user terminal leaves the original multicast group through the router by using the multicast group address of the original multicast stream and the IGMP so as to remove unnecessary multicast membership (operation S513).

The user terminal leaves the optimal multicast group, immediately when receiving the original multicast stream, so as to reduce a load of the IP network (operation S514).

Then, when the user changes a channel, the user terminal leaves the original multicast group on the original multicast stream (operation S515).

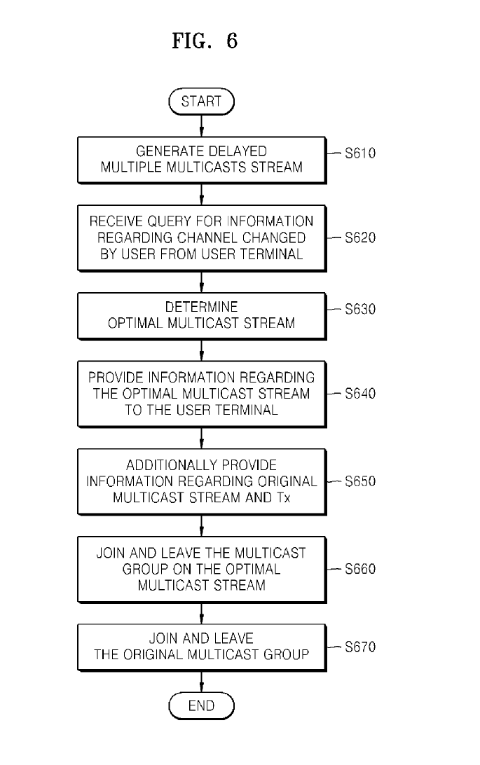

FIG. 6 is a flowchart of a fast channel change method using multiple multicasts communication in an IPTV network, according to an embodiment of the present invention, from a view of the channel server. Hereinafter, a detailed description on the parts that are the same as the aforementioned description will be omitted.

Referring to FIG. 6, the channel server generates at least one delayed multicast stream by applying different time delays respectively to original multicast streams (operation S610). Different multicast group addresses and/or different port values are applied to the delayed multicast streams. The different time delays are determined with a predetermined interval. The maximum delay among the time delays may be greater than a time T_{GOP} occupied by the GOP of the original multicast stream.

A query for information regarding the channel changed by the user is received from the user terminal (operation S620). The information query may include a channel ID such as a channel group address.

The optimal multicast stream is determined by analyzing the delayed multicast streams of the original multicast stream corresponding to the changed channel (operation S630). The delayed multicast stream capable of providing the I-frame the fastest based on the analysis result is determined as the optimal multicast stream.

The information regarding the optimal multicast stream is provided to the user terminal as a response to the query (operation S640). The multicast group address of the original multicast stream (or the delayed multicast stream of which the delayed value is zero), the port value of the original multicast stream, and the transition time Tₓ of the user terminal are additionally provided to the user terminal (operation S650).

The user terminal joins the optimal multicast group through the router by using the multicast group address of the optimal multicast stream. After a time for which the user terminal joins the optimal multicast group and receives the optimal multicast stream is elapsed, the user terminal leaves the optimal multicast group (operation S660).

After a transition time T_{Y} of the channel server is elapsed from when the user terminal joins the optimal multicast group, the user terminal joins the original multicast group through the router by using the multicast group address of the original multicast stream. After a time for which the user terminal joins the original multicast group and receives the original multicast stream is elapsed, the user terminal leaves the original multicast group (operation S670).

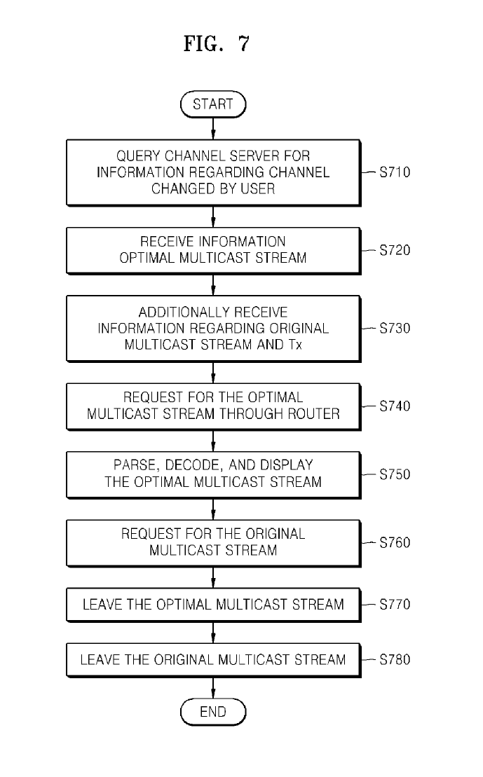

FIG. 7 is a flowchart of a fast channel change method using multiple multicasts communication in an IPTV network, according to another embodiment of the present invention, from a view of the user terminal. Hereinafter, a detailed description on the parts that are the same as the aforementioned description will be omitted.

Referring to FIG. 7, the user terminal queries the channel server for a channel changed by the user (operation S710).

Information regarding an optimal multicast stream determined among delayed multicast streams of an original multicast stream corresponding to the changed channel is received from the channel server (operation S720).

A multicast group address of the original multicast stream (the delayed multicast stream of which the delayed value is zero), a port value of the original multicast stream, and a transition time Tₓ of the user terminal are additionally provided (operation S730).

The optimal multicast stream is requested through the router by joining the optimal multicast group through the router based on information regarding the optimal multicast stream (operation S740).

The optimal multicast stream is received through the router, parsed, decoded, and output to a display (operation S750).

After a transition time of the user terminal is elapsed from when the user terminal joins the optimal multicast group, the original multicast stream is requested through the router by joining the original multicast group through the router based on the multicast group address of the original multicast stream (operation S760).

After receiving the original multicast stream through the router, the user terminal leaves the optimal multicast group (operation S770).

When the user changes the channel to another channel, the user terminal leaves the original multicast group (operation S780).

Although a fast channel change system using multicasts in an IPTV network and a method thereof are described by explaining respective embodiments, it will be understood by one of ordinary skill in the art that the present invention can be also applied to an IP network or RF network using broadcast communication.

As an example using broadcast communication, the channel server can separately generate at least one broadcast stream by applying different time delays respectively to original broadcast stream to be broadcast and periodically transmit information regarding the broadcast stream through a separate broadcast channel by dynamically analyzing the information regarding the broadcast stream.

The user terminal determines and receives an optimal broadcast stream by analyzing the information regarding the broadcast stream received through the separate broadcast channel. At this time, the stream information may include information regarding a position of a frame that is independently decodable in the at least one broadcast stream, information regarding a PAT, a PMT, and a CAT of the at least one broadcast stream, and the like. In addition, when the user terminal determines an optimal broadcast stream by analyzing the at least one broadcast stream information received through the separate broadcast channel, a broadcast stream capable of providing an independently decodable frame among the at least one broadcast stream the fastest may be determined as the optimal broadcast stream.

The invention can also be embodied as computer readable codes on a computer readable recording medium. The computer readable recording medium is any data storage device that can store data that can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by one skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. An IPTV (internet protocol TV) fast channel change method using multiple multicasts by a channel server, the IPTV fast channel change method comprising:
generating at least one delayed multicast stream by applying different time delays respectively to original multicast stream;
receiving a query from a user terminal for information regarding a channel changed by a user;
determining an optimal multicast stream by analyzing the delayed multicast streams of an original multicast stream corresponding to the changed channel; and
providing information regarding the optimal multicast stream to the user terminal as a response to the query.

2. The IPTV fast channel change method of claim 1, wherein different multicast group addresses or different port values are allocated to the delayed multicast streams.

3. The IPTV fast channel change method of claim 1, wherein the different time delays are determined with a predetermined time interval, and the maximum delay among the time delays is greater than a time occupied by a GOP (group of pictures) of the original multicast stream.

4. The IPTV fast channel change method of claim 1, wherein the determining of the optimal multicast stream includes:
analyzing a relative time position T₀ of an independent frame that is independently decodable with respect to the original multicast stream that is input into a multiple multicasts module of the channel server in real time and using a time calculated by using a distance between a current position of an independent frame in a stream buffer in the multiple multicasts module and an entrance to the stream buffer as the relative time position T₀;
analyzing multicast group addresses and port values of the delayed multicast streams;
analyzing program designation information including information regarding a PAT (Program Association Table), a PMT (Program Map Table), a CAT (Conditional Access Table);
determining a delayed multicast stream, which can provide the independent frame the fastest based on the analysis result, as the optimal multicast stream; and
providing information regarding the optimal multicast stream to the user terminal.

5. The IPTV fast channel change method of claim 1, further comprising joining multicast group on the optimal multicast stream through a router based on a multicast group address of the optimal multicast stream.

6. The IPTV fast channel change method of claim 5, wherein the joining of the multicast group on the optimal multicast stream is performed at the same time when the information regarding the optimal multicast stream is provided to the user terminal.

7. The IPTV fast channel change method of claim 6, further comprising joining the multicast group on the optimal multicast stream and leaving the multicast group on the optimal multicast stream, after a time for which the user terminal joins the multicast group on the optimal multicast stream and receives the multicast stream on the optimal multicast stream is elapsed.

8. The IPTV fast channel change method of claim 7, further comprising joining the multicast group on the optimal multicast stream through the router based on the multicast group address of the original multicast stream, after a predetermined time T_{Y} is elapsed from when the user terminal joins the multicast group on the optimal multicast stream.

9. The IPTV fast channel change method of claim 8, wherein the predetermined time T_{Y} is equal to or less than a transition time Tₓ of the user terminal, which corresponds to a time period when the user terminal joins the multicast group on the original multicast stream after joining the multicast group on the optimal multicast stream.

10. The IPTV fast channel change method of claim 9,
wherein the transition time Tₓ of the user terminal is determined by Tₓ=T_{GoP}−T₀+n×T_{GoP}+α, where n is zero or a natural number, T_{GOP} is a time occupied by a GOP (group of pictures), α is a compensation parameter, and T₀ is a relative time position of an independent frame in the optimal multicast stream.

11. The IPTV fast channel change method of claim 10, further comprising joining the multicast group on the original multicast stream and leaving the original multicast group, after a time for which the user terminal joins the multicast group on the original multicast stream and receives the original multicast stream is elapsed.

12. The IPTV fast channel change method of claim 1, wherein the information regarding the optimal multicast stream includes a multicast group address and a port value of the optimal multicast stream and program designation information.

13. The IPTV fast channel change method of claim 1, wherein in the providing the information to the user terminal, the information regarding the original multicast stream is additionally provided.

14. The IPTV fast channel change method of claim 13, wherein the information regarding the original multicast stream includes a multicast group address of the original multicast stream, a port value of the original multicast stream, and information regarding a transition time Tₓ of the user terminal.

15. An (interne protocol TV) IPTV fast channel change method using multiple multicasts by a user terminal, the IPTV fast channel change method comprising:
querying a channel server, which generates at least one delayed multicast stream by applying different time delays respectively to original multicast stream, for information regarding a channel changed by a user;
receiving, from the channel server, information regarding an optimal multicast stream determined among the delayed multicast streams of an original multicast stream corresponding to the changed channel;
requesting the optimal multicast stream by using the information regarding the optimal multicast stream through a router; and
receiving the optimal multicast stream from the router.

16. The IPTV fast channel change method of claim 15,
wherein the query includes a channel ID corresponding to the channel changed by the user, and
wherein the information regarding the optimal multicast stream includes a multicast group address and a port value of the optimal multicast stream and program designation information.

17. The IPTV fast channel change method of claim 15, wherein in the receiving the information regarding the optimal multicast stream, the information regarding the original multicast stream is additionally provided.

18. The IPTV fast channel change method of claim 17, wherein the information regarding the original multicast stream includes a multicast group address of the original multicast stream, a port value of the original multicast stream, and information regarding a transition time Tₓ of the user terminal.

19. The IPTV fast channel change method of claim 15, wherein the requesting for the optimal multicast stream includes requesting for the optimal multicast stream through the router by joining the multicast group on the optimal multicast stream based on the multicast group address on the optimal multicast stream

20. The IPTV fast channel change method of claim 15, further comprising requesting for the original multicast stream through the router by joining the multicast group on the original multicast stream through the router based on the multicast group address of the original multicast stream, after a predetermined time Tₓ is elapsed from when the user terminal joins the multicast group on the optimal multicast stream.

21. The IPTV fast channel change method of claim 20, wherein the predetermined time Tₓ, which is a transition time of the user terminal received from the channel server is equal to or greater than a transition time T_{Y} of the channel server, which corresponds to a time period when the channel server joins the multicast group on the original multicast stream after joining the multicast group on the optimal multicast stream, and
wherein the transition time Tₓ of the user terminal is determined by Tₓ=T_{GoP}−T₀+n×T_{GoP}+α, where n is zero or a natural number, T_{GOP} is a time occupied by a GOP (group of pictures), α is a compensation parameter, and T₀ is a relative time position of an independent frame in the optimal multicast stream.

22. The IPTV fast channel change method of claim 19, further comprising leaving the multicast group on the optimal multicast stream after receiving the original multicast stream.

23. The IPTV fast channel change method of claim 22, further comprising leaving the original multicast group, when the user changes the channel to another channel.
